(19) United States
(12) Patent Application Publication
(10) Pub. No.: US 2012/0147186 A1
(43) Pub. Date: Jun. 14, 2012

(54) SYSTEM AND METHOD FOR RECORDING TRACK OF VEHICLES AND ACQUIRING ROAD CONDITIONS USING THE RECORDED TRACKS

(75) Inventors: SuGil CHOI, Daejeon (KR); Moo Seop KIM, Daejeon (KR); Jong-Wook HAN, Daejeon (KR); Hong Il JU, Daejeon (KR); Min-ho HAN, Daejeon (KR); Jin Hee HAN, Daejeon (KR); Geonwoo KIM, Daejeon (KR); Su Wan PARK, Daejeon (KR); Yong-Sung JEON, Daejeon (KR); Young Sae KIM, Daejeon (KR)

(73) Assignee: Electronics and Telecommunications Research Institute, Daejeon (KR)

(21) Appl. No.: 13/303,259

(22) Filed: Nov. 23, 2011

(30) Foreign Application Priority Data
Dec. 14, 2010 (KR) 10-2010-0127716

(51) Int. Cl. H04N 7/18

(52) U.S. Cl. 348/148; 348/E07.085

(57) ABSTRACT

An image recording device mounted to a vehicle includes an imaging unit for capturing a sequence of images including an image of a road that the vehicle is running and circumstances around the road by taking photographs; an image management unit for storing the captured images in a recording medium and for extracting a target image corresponding to a request for image transmission from the recording medium; and a communication unit for receiving the request for image transmission and for transmitting the extracted images to the external entity.

### CROSS-REFERENCE TO RELATED APPLICATION(S)

The present invention claims priority of Korean Patent Application No. 10-2010-0127716, filed on Dec. 14, 2010, which is incorporated herein by reference.

### FIELD OF THE INVENTION

The present invention relates to a system and method for recording and keeping track of what happens on a road by taking photographs, and for acquiring road conditions from the recorded tracks.

### BACKGROUND OF THE INVENTION

Nowadays, the regions with security CCTV (closed-circuit television) cameras installed therein are ever increasing, and thus attempts to solve accidents occurred in the regions by analyzing CCTV images are being extended. However, a lot of dead zones still exist, and furthermore it is difficult to solve accidents occurred in the dead zones. Actually, the dead zones may be reduced to some extent by densely installing the CCTV cameras, but it is impossible to sufficiently install CCTV cameras in the entire dead zone. Moreover, in case of an accident involving a vehicle, the effectiveness of the CCTVs is decreased because the vehicle can move about in avoiding the CCTV cameras which are installed in roads.

Meanwhile, real-time road conditions may be collected and recognized real-time from either the CCTV cameras installed in roads or information giving by drivers. However, it is difficult to continuously collect and recognize every road condition.

### SUMMARY OF THE INVENTION

In view of the above, the present invention provides a system and method for recording and keeping track of what happens on a road by taking photographs.

Further, the present invention provides a system and method for acquiring road conditions from the recorded tracks.

In accordance with a first aspect of the present invention, there is provided an image recording device mounted to a vehicle, comprising:

an imaging unit for capturing a sequence of images including an image of a road that the vehicle is running, circumstances around the road, and the inside of the vehicle by taking photographs;

an image management unit for storing the captured images in a recording medium and for extracting a target image corresponding to a request for image transmission from the recording medium; and

a communication unit for receiving the request for image transmission and for transmitting the extracted images to the external entity.

Preferably, the image recording device further includes an authentication unit for performing an authentication for the external entity requesting the image transmission.

Preferably, the image recording device further includes a position tracking unit for detecting a position of the vehicle, the positional information is provided to an external entity issuing the request at regular intervals, and the image management unit appends the positional information of the vehicle and a timestamp representing a time when the captured images are taken when the captured images are stored in the recording medium.

Preferably, the target image includes images capturing a specific region and/or images captured for a specific period of time.

Preferably, the image recording device further includes an image recognition unit for analyzing the captured images to detect an accident therein.

Preferably, the accident includes an abnormally running vehicle, a site of traffic accidents, a drunken man on a road, and/or a criminal art around the road.

Preferably, the image recognition unit transmits the image containing the detected accident to a predetermined agency through the communication unit.

Preferably, the image recognition unit is further configured to recognize one or more objects around the vehicle when analyzing the captured images and to mask the recognized objects.

In accordance with a second aspect of the present invention, there is provided an image recording method, which includes:

capturing a sequence of images including an image of a road on which a vehicle is running, circumstances around the road, and the inside of the vehicle by taking photographs;

storing the captured images in a recording medium;

in response to receive a request to send a target image from an external entity, extracting the target image corresponding to the request from the recording medium; and

transmitting the target images to the external entity.

Preferably, the image recording method further includes:

analyzing the captured images to detect one or more objects around the vehicle; and

masking the recognized objects to protect the privacy of the recognized objects when the captured images are stored in the recording medium.

Preferably, the recognized objects include a license plate of other vehicles and a passerby that are contained in the captured images.

Preferably, the image recording method further includes:

analyzing the captured images to detect an accident contained therein; and

transmitting a portion of the captured images containing the detected accident to a predetermined agency.

Preferably, the accident includes an abnormally running vehicle, a site of traffic accident, a drunken man on a road, and/or a criminal act occurred around the road.

Preferably, the image recording method further includes:

detecting a position of the vehicle;

appending the positional information of the vehicle and a timestamp indicative of a time when the captured images are taken when the captured images are stored in the recording medium.

In accordance with a third aspect of the present invention, there is provided an apparatus for acquiring road conditions, the apparatus including;

an image request unit for making a request to send a target images from image recording devices, wherein each image recording devices having a sequence of images captured by taking photographs of a road on which a vehicle is running, circumstances around the road, and the inside of the vehicle;

an image extraction unit for analyzing the target images, which have been received from the respective image recording device by the request, to extract the road conditions from the target image; and

an image database for storing the extracted road conditions along with the target images.

Preferably, the apparatus further includes a positional information receipt unit for receiving positional information of the vehicles, and the image request unit requests the transmission of the target image on the basis of the positional information of the vehicles and current time.

Preferably, the request is broadcast to the image recording devices within a specific region.

Preferably, the respective image recording devices have different identifiers assigned thereto, respectively, and wherein the image request unit makes the request together with one or more the identifiers so that the image recording devices having the identifiers can send the target images.

In accordance with a fourth aspect of the present invention, there is provided a method for acquiring road conditions in associated with a plurality of image recording devices, each image recording device having a sequence of images captured by taking photographs of a road on which a vehicle is running, circumstances around the road, and the inside of the vehicle, the method including:

receiving positional information of the vehicles;

making a request to send a target image to one or more image recording devices in the vehicles within a specific region; and

analyzing the targets images, which have been received from the image recording devices by the request, to extract the road conditions.

Preferably, the respective image recording devices have different identifiers assigned thereto, respectively, and said making a request to send a target image to one or more image recording devices includes transmitting the request to the one or more image recording devices together with their identifiers so that each of the image recording devices having the identifiers can send the target image.

### BRIEF DESCRIPTION OF THE DRAWINGS

The above and other objects and features of the present invention will become apparent from the following description of embodiments given in conjunction with the accompanying drawings, in which:

FIG. 1 is a block diagram of a system for recording and keeping track of what happens on a road by taking photographs and for acquiring road conditions from the recorded tracks; and

FIG. 2 is a flow chart illustrating a process of acquiring road conditions in accordance with an embodiment of the present invention.

### DETAILED DESCRIPTION OF THE EMBODIMENTS

Hereinafter, embodiments of the present invention will be described in detail with reference to the accompanying drawings so that they can be readily implemented by those skilled in the art.

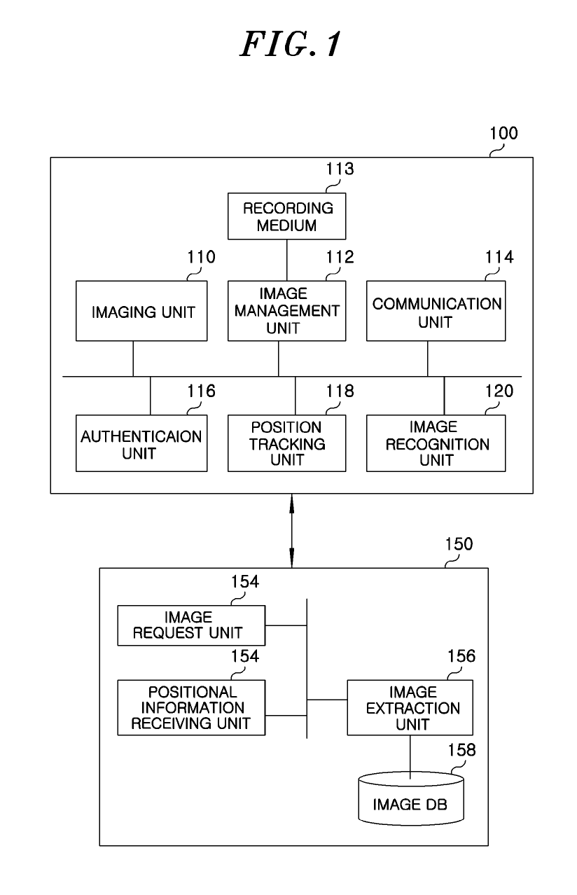

FIG. 1 is a block diagram of a system for recording and keeping track of what happens on a road by taking photographs and for acquiring road conditions from the recorded tracks.

As shown in FIG. 1, the system of the present invention includes a plurality of image recording devices 100 and an apparatus 150 for acquiring road conditions.

The respective recording devices 100 are mounted on vehicles to record and keep tracks of what happen on the road on which the vehicles are running. The apparatus 150 is located far from the recording devices 100 and acquires road conditions by analyzing the captured images provided by the respective recording devices 100 at remote location.

Each of the image recording devices 100 has identifier assigned thereto so that the apparatus 150 selectively designates one or more image recording devices 100 to send a desired image. The recording device 100 includes an imaging unit 110, an image management unit 112, a communication unit 114, an authentication unit 116, a position tracking unit 118, and an image recognition unit 120.

The imaging unit 110 may include an image camera which is mounted to the inside and/or outside of the vehicle. In case where the imaging unit is mounted to the outside of the vehicle, the imaging unit 110 captures an image of the road that the vehicle is running, inclusive of other vehicles on the road, and circumstances around the road. Meanwhile, in case where the imaging unit 110 is mounted to the inside of the vehicle, the imaging unit 110 captures an image of the inner space of the vehicle. The images captured by the imaging unit 110 are provided to the image management unit 112.

The image management unit 112 includes a recording medium 113 for storing the captured images, for example, at least one of non-volatile recording mediums such as, EEPROM (Eelectrically Erasable Programmable Read-Only-Memory), flash memory, magnetic tape and optical disc. The image management unit 112 records the image provided from the imaging unit 110 together with a time stamp indicative of a time when the image is captured and a position of the vehicle into the recording medium 113. When receiving a request to send a target image that has been captured for specific period of time and at a specific region from the apparatus 150, the image management unit 112 extracts the target image corresponding to the request and transmit the extracted target images to the apparatus 150 via the communication unit 114.

Further, the image management unit 112 is programmed to transmit a portion of the captured image associated with accidents or incidents to a designated entity when the accidents or incidents are recognized in the captured image. For example, the image management unit 112 may transmit the image containing abnormally driving vehicle and a site of traffic accident to a police server. In addition, the image management unit 112 may transmit the image containing an injured victim of traffic accident or a drunken man on a road to a 911 server.

The communication unit 114 communicates with the apparatus 150 and is always ready to receive the request for image transmission from the apparatus 150. The request received through the communication unit 114 is first applied to the authentication unit 116 before responding to the request.

The authentication unit 116 authenticates an entity issuing the request in order to verify whether the entity is reliable. This authentication enables to prevent the indiscreet leakage of the captured images, thereby protecting the privacy of the passerby or a driver in the captured images. Therefore, whenever the request is received, the authentication unit 116 authenticates the entity issuing the request and transmits the image corresponding to the request to the authenticated entity.

The position tracking unit 118 continues to locate the vehicle having the image recording device 100 and obtains the position at which an image is captured. For example, the position tracking unit 118 may be implemented as a GPS (Global Positioning System) receiver. The positional information obtained by the position tracking unit 118 is provided to both the image management unit 112 and the apparatus 150. In addition, the positional information of the vehicle may be provided directly to a server of the relevant agency such as the national police agency or the 911.

The image recognition unit 120 analyzes the captured image to detect presence of an accident contained therein using an image recognition technique well known in the art. Further, the image recognition unit 120 recognizes one or more objects, such as a license plate of the nearby vehicle or a passerby, contained in the captured image with the detected accident and masks the recognized objects. This masking may protect the privacy for the driver or the passerby.

If any accident is detected in the captured image, the image recognition unit 120 may inform the detected accident of the image management unit 112. In response to the notification, the image management unit 112 may transmit a portion of the captured image that have been captured during a predetermined period of time from the time when the accident has occurred or the earlier time than the time of the accident to the designated agency, such as a national police or the 911. The term “detected accident” used herein means unfavorable events including an abnormally running vehicle, a site of traffic accident, an injured victim of traffic accident or a drunken man on a road, a criminal act around the road, and so on.

On the other hand, as shown in FIG. 1, the apparatus 150 includes an image request unit 152, a position receiving unit 154, an image extraction unit 156 and an image database 158.

The apparatus 150 communicates with the image recording devices 100 through a network (not shown) to make a request to transmit a target image under consideration of vehicle's position, time, and circumstances around the road. Upon the receipt of the target image, the apparatus 150 analyzes the target image to extract road conditions from the target image.

The image request unit 152 serves to request the recording devices 100 to send the target image. The request may be transmitted to every recording device 100 in a broadcast mode under consideration of vehicle's position and current time, or the request may be transmitted to particular recording devices 100 using the their identifiers ID in a multicast mode.

The positional information receipt unit 154 is configured to receive the vehicle's position from the position tracking unit 118 in the recording device 100.

The image extraction unit 156 analyzes the target images that are received by the request to extract road conditions. The road conditions extracted by the extraction unit 156 are stored along with the target images in the image database 158.

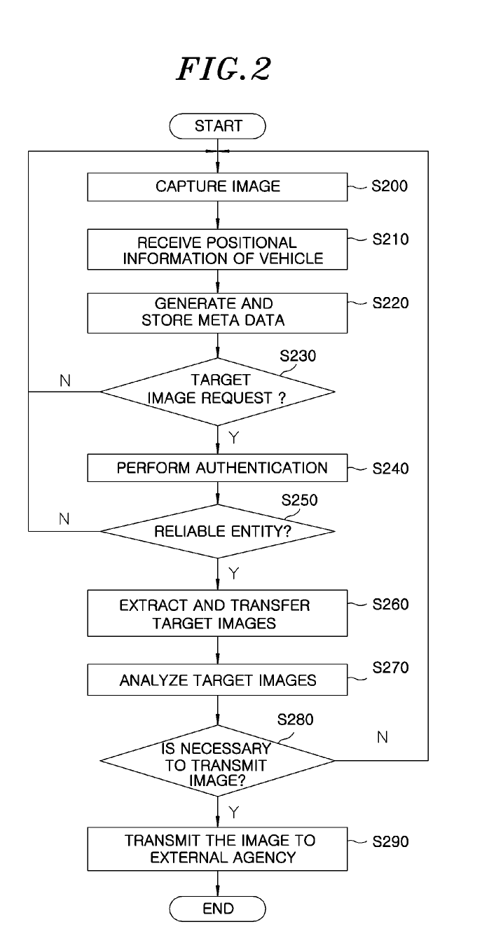

FIG. 2 is a flow chart illustrating a process of acquiring road conditions in accordance with an embodiment of the present invention.

As shown in FIG. 2, in step S200, the image recording device 100 captures a sequence of images including an image of the road that the vehicle is running, other vehicles on the road, and circumstances around the road, and an inner space of the vehicle. The sequence of images captured by the imaging unit 110 is delivered to the image management unit 112.

In step S210, the position tracking unit 118 continues to detect the position of the vehicle and provides the detected positional information of the vehicle to the image management unit 112.

In step S220, the image management unit 112 appends the positional information and the time stamp to the captured image and produces meta data for the captured image. The meta data is stored along with the captured image in the recording medium 113.

Thereafter, in step S230, it is determined if a request to transmit a target image is received through the communication unit 114. If it is determined that the request is received, the process advances to step S240; however, if not, the image recording device 100 awaits the request for image transmission.

In step S240, the request for image transmission is transferred to the authentication unit 116 performs an authentication for an entity issuing the request.

Subsequently, as a result of the authentication, it is determined whether or not the entity is reliable. If it is determined that the entity is reliable, the process goes to step S260 where the authentication unit 116 relays the request to the image management unit 112.

However, If it is determined that the entity is unreliable, the authentication unit 116 does not reply to the request.

After that, in step S270, the image management unit 112 extracts the target image corresponding to the request from the storage unit 103. For example, in case where the request for a target image relates to a request for a real-time image, the image management unit 112 directly transmits the real-time image and simultaneously stores in the recording medium 103. However, in case where the request for a target image relates to a request for a particular region or date and time, the image management unit 112 extracts and transmits the target image corresponding to the particular region or data and time from the recording medium 103 using the meta data.

As set forth above, although it has been exemplarily described that the captured image is transmitted to the exterior only when the request for image transmission is received, the embodiment of the present invention is further configured to transmit the captured image to a previously designated agency when an abnormal circumstance is detected in the captured image. More specifically, the embodiment of the present invention analyzes the captured image and recognizes an abnormal circumstance including an abnormally running vehicle, a site of traffic accident, a drunken man on a road, and the like. If the abnormal circumstance is recognized, a portion of the captured image containing the abnormal circumstance is transmitted to the designated agency. In addition, the embodiment of the present invention may recognize a license plate of another vehicle and the face of the passerby through the image recognition technique and mask the detected license plate and the passerby's face, before storing the captured image.

Therefore, in step S280, on the basis of the analyzed result as in step S270, it is determined whether or not it is necessary to transmit the captured image.

As a result of the determination, if it is necessary to transmit a portion of the captured image containing the abnormal circumstance, the image recognition unit 120 informs the image management unit 112 of the necessity of the image transmission. Accordingly, in step S290, the image management unit 112 transmits a portion of the captured image containing the abnormal circumstance to the designated agency, such as a national police agency, a 911, a central natural disaster, or the like.

Meanwhile, in the embodiment of the present invention as described above, in order to allow the apparatus 150 to detect the circumstances at a specific region, the request for the target image is transmitted to every image recording devices within the specific region. Alternatively, the embodiment of the present invention may a request for the target image to one or more particular image recording devices while tracking the vehicles having the particular image recording devices. In this case, it is necessary to continuously transmit the positional information of the vehicles having the particular image recording devices. To this end, the position tracking unit 118 is configured to transmit the positional information of the vehicles having the particular image recording devices to the apparatus 150 through the communication unit 114.

In accordance with the present invention, there may be a high possibility that accidents occurring around a road will be recorded in the image recording device for a vehicle. Therefore, the present invention makes it possible to either recognize an accident occurring around the road, or catch circumstances around the road. Moreover, a traffic circumstance at a specific region in which CCTV cameras are not installed, and an accident occurring in the specific region may be detected using the images recorded in the image recording device for a vehicle which is currently passing or previously has passed the specific region. In addition, the present invention enables a runaway vehicle to be tracked in real time by analyzing the images which are captured by another image recording devices installed within vehicles on a predicted runaway path.

While the invention has been shown and described with respect to the preferred embodiments, it will be understood by those skilled in the art that various changes and modifications may be made without departing from the scope of the invention as defined in the following claims.

What is claimed is:

1. An image recording device mounted to a vehicle, comprising:
an imaging unit for capturing a sequence of images including an image of a road that the vehicle is running and circumstances around the road by taking photographs;
an image management unit for storing the captured images in a recording medium and for extracting a target image corresponding to a request for image transmission from the recording medium; and
a communication unit for receiving the request for image transmission and for transmitting the extracted images to the external entity.

2. The image recording device of claim 1, further comprising an authentication unit for performing an authentication for the external entity requesting the image transmission.

3. The image recording device of claim 1, further comprising a position tracking unit for detecting a position of the vehicle,
wherein the positional information is provided to an external entity issuing the request at regular intervals, and
wherein the image management unit appends the positional information of the vehicle and a timestamp representing a time when the captured images are taken when the captured images are stored in the recording medium.

4. The image recording device of claim 3, wherein the target image includes images capturing a specific region and/or images captured for a specific period of time.

5. The image recording device of claim 1, further comprising an image recognition unit for analyzing the captured images to detect an accident therein.

6. The image recording device of claim 5, wherein the accident includes an abnormally running vehicle, a site of traffic accidents, a drunken man on a road, and/or a criminal art around the road.

7. The image recording device of claim 5, wherein the image recognition unit transmits the image containing the detected accident to a predetermined agency through the communication unit.

8. The image recording device of claim 5, wherein the image recognition unit is further configured to recognize one or more objects around the vehicle when analyzing the captured images and to mask the recognized objects.

9. An image recording method comprising:
capturing a sequence of images including an image of a road on which a vehicle is running and circumstances around the road by taking photographs;
storing the captured images in a recording medium;
in response to receive a request to send a target image from an external entity, extracting the target image corresponding to the request from the recording medium; and
transmitting the target images to the external entity.

10. The image recording method of claim 9, further comprising:
analyzing the captured images to detect one or more objects around the vehicle; and
masking the recognized objects to protect the privacy of the recognized objects when the captured images are stored in the recording medium.

11. The image recording method of claim 10, wherein the recognized objects include a license plate of other vehicles and a passerby that are contained in the captured images.

12. The image recording method of claim 9, further comprising:
analyzing the captured images to detect an accident contained therein; and
transmitting a portion of the captured images containing the detected accident to a predetermined agency.

13. The image recording method of claim 12, wherein the accident includes an abnormally running vehicle, a site of traffic accident, a drunken man on a road, and/or a criminal act occurred around the road.

14. The image recording method of claim 9, further comprising:
detecting a position of the vehicle;
appending the positional information of the vehicle and a timestamp indicative of a time when the captured images are taken when the captured images are stored in the recording medium.

15. An apparatus for acquiring road conditions, the apparatus comprising;
an image request unit for making a request to send a target images from image recording devices, wherein each image recording devices having a sequence of images captured by taking photographs of a road on which a vehicle is running and circumstances around the road;
an image extraction unit for analyzing the target images, which have been received from the respective image recording device by the request, to extract the road conditions from the target image; and
an image database for storing the extracted road conditions along with the target images.

16. The apparatus of claim 15, further comprising a positional information receipt unit for receiving positional information of the vehicles,
wherein the image request unit requests the transmission of the target image on the basis of the positional information of the vehicles and current time.

17. The apparatus of claim 15, wherein the request is broadcast to the image recording devices within a specific region.

18. The apparatus of claim 15, wherein the respective image recording devices have different identifiers assigned thereto, respectively, and wherein the image request unit makes the request together with one or more the identifiers so that the image recording devices having the identifiers can send the target images.

19. A method for acquiring road conditions in associated with a plurality of image recording devices, each image recording device having a sequence of images captured by taking photographs of a road on which a vehicle is running and circumstances around the road, the method comprising:
receiving positional information of the vehicles;
making a request to send a target image to one or more image recording devices in the vehicles within a specific region; and
analyzing the targets images, which have been received from the image recording devices by the request, to extract the road conditions.

20. The method of claim 19, wherein the respective image recording devices have different identifiers assigned thereto, respectively, and
wherein said making a request to send a target image to one or more image recording devices includes transmitting the request to the one or more image recording devices together with their identifiers so that each of the image recording devices having the identifiers can send the target image.
